(19) United States
(12) Patent Application Publication
(10) Pub. No.: US 2010/0184401 A1
(43) Pub. Date: Jul. 22, 2010

(54) SAFETYLERT

(75) Inventor: Mary Elizabeth Spence, Timonium, MD (US)

Correspondence Address: MARY E SPENCE, 501 HAWKSHEAD ROAD, LUTHERVILLE, MD, 21093, US

(73) Assignee: Mary Elizabeth Spence, Timonium, MD (US)

(21) Appl. No.: 12/733,198

(22) PCT Filed: Aug. 26, 2008
(86) PCT No.: PCT/US08/10096

§ 371 Date: Feb. 16, 2010

Related U.S. Application Data
(63) Continuation of application No. 12/070,674, filed on May 6, 2008.
(60) Provisional application No. 61/029,662, filed on Feb. 19, 2008.

(51) Int. Cl. H04M 11/04

(52) U.S. Cl. 455/404.2

(57) ABSTRACT

This present invention relates generally to wireless communications and emergency services. Safetylert, is an apparatus and method of an equipped GPS/A-GPS, GPS Reverse Geocoder wireless remote unit and/or an equipped GPS/A-GPS, GPS Reverse Geocoder wireless cell phone, also referred to as “communication device(s)” that can automatically transmit relevant information to a PSAP, when emergency services (i.e. 911) is prompted (emergency button) and/or dialed; the transmitted data information will enhance personal and medical safety, etc.; it will aid in countering terrorism (this equipment can be embedded within and applied to Voice Over Internet Protocol telephones, commonly known as “IP or VOIP” telephones, etc.). A Public Safety Answering Point (PSAP) is a call center responsible for answering calls to an emergency telephone number (i.e. 911) for police, firefighting, and ambulance. Trained telephone operators are usually responsible for dispatching these emergency services.

The inventive step of this present invention, Safetylert, is the installation of the GPS Reverse geocoder database software technology embedded within the equipped GPS/A-GPS wireless “remote unit” and/or an equipped GPS/A-GPS wireless “cell phone handset”. Embedding the GPS reverse geocoder database software technology within each respective device(s), enables the ability for device(s) to automatically transmit relevant data information (i.e. actual street address format, and other non traditional formats, etc.) to a PSAP operator, when “911” is prompted (emergency button) and/or dialed; aiding the PSAP operator with necessary location/tracking information to dispatch emergency responders to the device location. Again, this equipment/inventive step can be embedded within and applied to “VOIP” telephones, etc.

The GPS reverse geocoder database software technology, embedded within each respective device, significantly increase the accuracy of address intelligence and emergency response time, quickly locating device. The embodiment of this invention will give emergency officials the capability of intervening or preventing an act of crime; prompt assistance in a medical emergency, prevents the loss of valuable time, etc. The information transmitted to the E911/911 emergency service (PSAP) from the equipped GPS/A-GPS, GPS Reverse Geocoder wireless remote unit and/or equipped GPS/A-GPS, GPS Reverse Geocoder wireless cell phone is similar to the traditional landline format. Long-Felt Need: This problem and particular area facing wireless telecommunications and the E911/911 system (as well as VOIP, etc.) has gone unsolved for a prolonged period. The presumption is if the solution had been obvious to those skilled in the art, they would have solved the problem.

### FIELD OF INVENTION

This application claims benefit to U.S. Provisional application patent application No. 61/029,662 and U.S. Non Provisional Application No. 12/070,674, which is hereby incorporated by reference. While this invention and respective device(s) have been described and illustrated in various embodiments, such descriptions are merely illustrative of this invention and respective device(s) and are not to be construed to be limitations thereof. In this regard, this invention and respective device(s) encompasses any and all modifications, variations and/or alternative embodiments with the scope of this invention being limited only by the claims which follow. Current and future wireless technology is to be considered incorporated within each respective device, i.e. IDEN, ESN, NAM, WIDEN, UMTS, MIN, PCS, etc.

This present invention relates generally to wireless communications and emergency services. Safetylert, is an apparatus and method of an equipped GPS/A-GPS, GPS Reverse Geocoder wireless remote unit and/or an equipped GPS/A-GPS, GPS Reverse Geocoder wireless cell phone, also referred to as “communication device(s)” that can automatically transmit relevant information to a PSAP, when emergency services (i.e. 911) is prompted (emergency button) and/or dialed; the transmitted data information will enhance personal and medical safety, etc.; it will aid in countering terrorism (this equipment can be embedded within and applied to Voice Over Internet Protocol telephones, commonly known as “IP or VOIP” telephones, etc.). A Public Safety Answering Point (PSAP) is a call center responsible for answering calls to an emergency telephone number (i.e. 911) for police, firefighting, and ambulance. Trained telephone operators are usually responsible for dispatching these emergency services. Relevant data information that can be transmitted is further discussed within claim 2.

The inventive step of this present invention, Safetylert, is the installation of the GPS Reverse geocoder database software technology embedded within the equipped GPS/A-GPS wireless “remote unit” and/or an equipped GPS/A-GPS wireless “cell phone handset”. Embedding the GPS reverse geocoder database software technology within each respective device(s), enables the ability for device(s) to automatically transmit relevant data information (i.e. actual street address format, and other non traditional formats, etc.) to a PSAP operator, when “911” is prompted (emergency button) and/or dialed; aiding the PSAP operator with necessary location/tracking information to dispatch emergency responders to the device location. Again, this equipment/inventive step can be embedded within and applied to “VOIP” telephones, etc.

The GPS reverse geocoder database software technology, embedded within each respective device, significantly increases the accuracy of address intelligence and emergency response time, quickly locating device. The embodiment of this invention will give emergency officials the capability of intervening or preventing an act of crime; prompt assistance in a medical emergency, prevents the loss of valuable time, etc.

GPS Reverse Geocoder Database Software: This database software technology is utilized to process and convert GPS latitude-longitude coordinates into a street address format and/or descriptive location, etc.

Geocoding tools such as “Reverse Geocoding” (database software technology) can identify and generate map-location and/or nearest street address to a latitude-longitude coordinate and vice versa. Geocoding database software technology can significantly increase the accuracy of address intelligence and emergency response time; quickly locating the customer i.e. child, adult, senior, etc. (i.e. utilizing a Geographic Information System “GIS” a mapping system which combines positional data with descriptive information to form a layered map).

GPS Reverse Geocoder database software technology to include street network data assigned by the U.S. Postal Service or software that is equal or better that can identify adjacent cross streets; geocoding the customer information data and displaying on a map, you can get quick indication of location. Mapping and reverse geocoding can also be applied to many countries around the world. Respective device(s) can be modified to be used globally (i.e. SIM Card: chip/card that contains user account information and can be individually programmed for personalized services, for example, ArcGis is a complete system for authoring, serving, and using geographic information. It is an integrated collection of GIS software products for building and deploying a complete GIS wherever it is needed, on desktops, servers, or custom applications, etc. GIS integrates hardware, software, etc.).

Some of the pertinent/relevant location/tracking information provided to a PSAP, is as follows: (1) unit carrier, also known as wireless service provider; in past the assigned wireless cellular phone number depicted associated carrier name (2) assigned wireless cellular phone number (3) the location of GPS wireless remote unit and/or GPS wireless cellular phone in street address format, etc., address will automatically update if the remote unit and/or wireless cellular phone changes position/location. Further documentation and discussion within Description of Drawings.

The information transmitted to the E911/911 emergency service (PSAP) from the equipped GPS/A-GPS, GPS Reverse Geocoder wireless remote unit and/or equipped GPS/A-GPS, GPS Reverse Geocoder wireless cell phone is similar to the traditional landline format. A brief overview of a traditional landline and of existing PSAP (E911/911 emergency call centers); as well as FCC “E911” Program/Phases and “VOIP” is further documented and discussed within the patent application and Description of Drawings.

Long-Felt Need: This problem and particular area facing wireless telecommunications and the E911/911 system (as well as VOIP, etc.) has gone unsolved for a prolonged period. The presumption is if the solution had been obvious to those skilled in the art, they would have solved the problem.

It is essential for each state to utilize geocoding tools (i.e. GPS reverse geocoder database software technology), etc. as part of their E911 system implementation; the remote unit and/or cell phone customer in distress may not know their current location or may become unavailable.

Wireless service providers would benefit by deploying this present invention; as the “FCC E911 program, phase 2” requires wireless service providers to more accurately locate cell phones in case of emergencies. The phone manufactures, service providers and PSAP's have not been able to comply with the deadline. Further documentation and discussion within the patent application.

Safetylert, is a solution as well as an invention. This present invention will: (1) improve the present E911/911 system in terms of wireless communications, i.e. GPS reverse geocoder database software technology embedded within equipped GPS/A-GPS wireless remote unit and/or equipped GPS/A-GPS wireless cell phone; (2) provide safety enhancement to consumers, as well as our country; (3) assist wireless service providers with meeting the “FCC 911 Program” requirements and deadlines; (4) opportunity for wireless service providers to create “additional revenue”, i.e. software updates etc., see #6 of this paragraph; (5) aid the government with combating terrorism; (6) afford the federal government the opportunity for “additional revenue”; via a government tax or charge for the GPS satellite network, etc. (7) the ability to have a universal E911/911 system via a central “PSAP” and/or reduce the number of “PSAP” centers needed; while improving the safety of our country.

This present invention will not only provide advantages, solution and benefits to the “E911/911” system; additionally the equipment/inventive step of this present invention can be applied to VOIP telephones, etc. (i.e. GPS reverse geocoder database software technology embedded within phone, etc.).

In addition to possible “generating revenue” opportunity previously stated, the U.S. Postal Service has an updated address database software (i.e. Cass, etc.) that can be licensed and the information can be purchased/sold to outside vendors, similar to “Cass” etc.

### SUMMARY OF INVENTION

What its applications are:

The general public assumes that when they call 911 from a wireless cellular phone it is the same as if they were calling from a “traditional landline”, a false sense of security is instilled within our society.

The inventive step of this present invention, Safetylert, is the installation of the GPS Reverse geocoder database software technology embedded within the equipped GPS/A-GPS wireless “remote unit” and/or an equipped GPS/A-GPS wireless “cell phone handset”. Embedding the GPS reverse geocoder database software technology within each respective device(s), enables the ability for device(s) to automatically transmit relevant data information (i.e. actual street address format, and other non traditional formats, etc.) to a PSAP operator, when “911” is prompted (emergency button) and/or dialed; aiding the PSAP operator with necessary location/tracking information to dispatch emergency responders to the device location. Again, this equipment/inventive step can be embedded within and applied to “VOIP” telephones, etc.

The GPS reverse geocoder database software technology, embedded within each respective device, significantly increases the accuracy of address intelligence and emergency response time, quickly locating device. The embodiment of this invention will give emergency officials the capability of intervening or preventing an act of crime; prompt assistance in a medical emergency, prevents the loss of valuable time, etc.

GPS Reverse Geocoder Database Software: This database software technology is utilized to process and convert GPS latitude-longitude coordinates into a street address format and/or descriptive location, etc.

Geocoding tools such as “Reverse Geocoding” (database software technology) can identify and generate map-location and/or nearest street address to a latitude-longitude coordinate and vice versa. Geocoding database software technology can significantly increase the accuracy of address intelligence and emergency response time; quickly locating the customer i.e. child, adult, senior, etc. (i.e. utilizing a Geographic Information System “GIS” a mapping system which combines positional data with descriptive information to form a layered map).

Long-Felt Need: This problem and particular area facing wireless telecommunications and the E911/911 system (as well as VOIP, etc.) has gone unsolved for a prolonged period. The presumption is if the solution had been obvious to those skilled in the art, they would have solved the problem.

PROPOSAL

The present E911/911 emergency service is paid for by everyone that has a land and/or wireless cellular phone. A percentage is added to each land and wireless cell phone statement to fund the E911/911 service/method for the telephone companies.

Our country, law enforcement and wireless service providers, etc. would benefit by adapting, utilizing and deploying this present invention. Wireless service providers would benefit by deploying this present invention; as the “FCC E911 program, phase 2” requires wireless service providers to more accurately locate cell phones in case of emergencies.

As previously stated the government has stepped in to ensure that E911 capabilities are improved. The FCC “E911 program” requires that all cell phones transmit their phone number and location when dialing 911.

The FCC gave phone manufactures, service providers and PSAP's until the end of 2005 to comply with this ruling. This is one of the reason why new wireless cell phones have GPS receivers built in, even if they can't provide the turn-by-turn directions.

The phone manufactures, service providers and PSAP's have not been able to comply with the above deadline. Again, “Safetytlert” is a solution as well as an invention.

The implementation of Phase 11 technology introduces new commercial opportunities. As mentioned in the previous section, location-based methods will leverage the infrastructure of E-911 technology to deliver commercial service to phones, including advertising. These new technologies also create concerns over privacy. In particular, see below item(s) 1, 2 and 3 for additionally benefits of this present invention as it relates to the “FCC 911 Program”.

I propose the following revenue generating methods in conjunction with this present invention:

1. Privacy concerns:

Some worry about the government knowing their whereabouts, stalkers spying on them or even a spouse monitoring their movements. Although the technology could allow anyone to find you at any given moment, measures are being taken to prevent this kind of abuse. Wireless companies are ensuring consumers that federal law prevents these scenarios from happening. The provision stated below (under “Solution”) is intended to protect consumers' information from being given out. However, consumers must decide how much privacy they are willing to trade for the conveniences and benefits offered by location-tracking technology.

Solution:

Pursuant to the FCC, “Basic 911 Rules” require wireless service providers to transmit all 911 calls to a Public Safety Answering Point (PSAP), regardless of whether the caller subscribes to the provider's service or not. Wireless service providers would benefit by adapting and utilizing this present invention.

Wireless service provider, etc. utilizing this present invention will have the “customer” complete and sign a contract that includes a “DISCLOSURE ON REQUEST BY CUSTOMER” in accordance with the FCC Communications Act 1934 (1999 amendment adding section 222) that authorizes the GPS wireless service provider, PSAP (E911/911) call center and/or emergency dispatch service centers the ability to track and dispatch their GPS coordinates/address/map location to emergency officials in the event of receiving an emergency distress signal/call.

Additional Information:

In 1999, the U.S. Congress amended the Communications Act of 1934 to include a privacy provision by adding section 222, which states: 222 (a) Every telecommunications carrier has a duty to protect the confidentiality of proprietary information of, and relating to customers. (b) A telecommunications carrier that receives or obtains proprietary information from another carrier for purposes of providing any telecommunications service shall use such information only for such purpose, and shall not use such information for its own marketing efforts. (c)(1) PRIVACY REQUIREMENTS FOR TELECOMMUNICATIONS CARRIERS.—Except as required by law or with the approval of the customer, a telecommunications carrier that receives or obtains customer proprietary network information by virtue of its provision of a telecommunications service shall only use, disclose, or permit access to individually identifiable customer proprietary network information in its provision of (A) the telecommunications service from which such information is derived, or (B) service necessary to, or used in, the provision of such telecommunications service, including the publishing of directories. (2) DISCLOSURE ON REQUEST BY CUSTOMERS. A telecommunications carrier shall disclose customer proprietary network information, upon affirmative written request by the customer, to any person designated by the customer.

2. Revenue for Wireless Providers:

The present E911/911 emergency service is paid for by everyone that has a land and/or wireless cellular phone. A percentage is added to each land and wireless cell phone statement to fund the E911/911 service/method for the telephone companies.

I propose this present invention be a “customer paid for. Wireless service providers would benefit by adapting, utilizing and deploying this present invention; as the “FCC E911 program, phase 2” requires wireless service providers to more accurately locate cell phones in case of emergencies.

This present invention will: (1) improve the present E911/911 system; (2) provide safety enhancement to consumers, as well as our country; (3) assist wireless service providers with meeting the “FCC 911 Program” requirements and deadlines; (4) opportunity for wireless service providers to create “additional revenue” i.e. software updates etc., see #6 of this paragraph; (5) aid the government with combating terrorism; (6) afford the federal government the opportunity for “additional revenue”; via a government tax or charge for the GPS satellite network, etc.; (7) the ability to have a universal E911/911 system via a central “PSAP” and/or reduce the number of “PSAP” centers needed; while improving the safety of our country.

This present invention will not only provide advantages, solution and benefits to the “E911/911” system; additionally the equipment/inventive step of this present invention can be applied to VOIP telephones, etc. (i.e. GPS reverse geocoder database software technology embedded within phone, etc.).

In addition to possible “generating revenue” opportunity previously stated, the U.S. Postal Service has a consistently updated address database software (i.e. Cass, etc.) that can be licensed and the information can be purchased/sold to outside vendors, similar to “Cass” etc.

3. Revenue for Government:

The federal government (U.S. Military) developed and implemented the satellite network as a military navigation system, but soon opened it up freely.

As previously stated, wireless service providers would benefit by adapting and utilizing this present invention; I propose, wireless service providers (i.e. customer) pay a government fee or tax for the use of the GPS satellite network.

This present invention will: (1) improve the present E911/911 system; (2) provide safety enhancement to consumers, as well as our country; (3) assist wireless service providers with meeting the “FCC 911 Program” requirements and deadlines; (4) opportunity for wireless service providers to create “additional revenue” i.e. software updates etc., see #6 of this paragraph; (5) aid the government with combating terrorism; (6) afford the federal government the opportunity for “additional revenue”; via a government tax or charge for the GPS satellite network, etc. (7) the ability to have a universal E911/911 system via a central “PSAP” and/or reduce the number of “PSAP” centers needed; while improving the safety of our country.

This present invention will not only provide advantages, solution and benefits to the “E911/911” system; additionally the equipment/inventive step of this present invention can be applied to VOIP telephones, etc. (i.e. GPS reverse geocoder database software technology embedded within phone, etc.).

The existing PSAP (E911/911) call centers are not all located within a telephone company building; some are located within police departments or city/county locations, etc. This information is universal within the United States.

A Brief Overview of Existing PSAP:

The following is example(s) of a PSAP operator receiving an emergency call from a GPS wireless cellular phone; if the wireless cellular phone is not GPS enabled, the operator will not receive location coordinates; in addition the PSAP must have the ability i.e. Enhanced 911 to receive coordinates, etc., addition information within this section;

PSAP located within a police department (i.e. Maryland):
PSAP operator receives an emergency call from a wireless cellular phone, the PSAP operator does
not receive GPS coordinates, therefore, in the event of an emergency the police or emergency officials will
have to go back to the cellular carrier (i.e. Verizon) to see what cells tower(s) the call came from. Emergency
officials can only search the triangular area around the cell tower(s) the call originated from. The maximum
range of a cell tower (mast) where it is not limited by interference of other masts nearby varies from 20-45
miles. Valuable time is lost and the search is not accurate if the customer in distress keeps moving with their
turned on wireless cell phone and if the wireless cellular phone is turned off the call will terminate.
E911/911-PSAP located within a telephone company building:
PSAP (E911) operator receives an emergency call from a GPS wireless cell phone; the PSAP
operator will receive GPS coordinates, but not an exact address. I was informed that the telephone company's
current policy and protocol is as follows “a dispatcher is not allowed to give out the GPS coordinates” no
matter what the circumstances are due to FCC Privacy Tracking. PSAP (911) operator receives emergency
call from wireless cell phone with no information.

When someone dials 911 from a landline, the call is automatically forwarded to a public-safety answering point (PSAP), also called an E911 call center. When the call is answered, the 911 operator is immediately provided with automatic location information (ALI), pinpointing the exact position of the call; if the “caller” hangs up or can't speak the PSAP operator knows where to send help.

Due to the number of emergency calls originating from wireless cellular phones, the government has stepped in to ensure that E-911 capabilities are improved.

New technologies being developed by wireless service/method providers at the demand of the FCC are expected to enhance the location-finding ability of E-911 to locate the exact position of a wireless emergency call.

The FCC is rolling out E-911 in phases:

| | |
|---|---|
| Phase 0: | This is the basic 911 process. Wireless calls are sent to a PSAP. Service providers |
| | must direct a call to a PSAP even if the caller is not a subscriber to their service. |
| Phase I: | The FCC's rule requires that a phone number display with each wireless 911 call, |
| | allowing the PSAP operator to call back if there is a disconnection. |
| Phase II: | The final phase requires carriers to place GPS receivers in phones in order to deliver |
| | more specific latitude and longitude location information. Location information must |
| | be accurate within 164 to 984 feet (50-300 meters). |

Without Phase II, a caller's location can only be narrowed down to the cell tower from which the call originated. When Phase II is implemented, a cell-phone user's phone number, or Automatic Number Identification (ANI), and the address and location of the receiving-antenna site will be sent to the E-911 Tandem, the switch that routes 911 calls to the appropriate PSAP based on the ANI-defined geographic location.

Once the caller's voice and ANI are transferred to the PSAP, the PSAP operator will be able to view a graphic display that shows the longitude and latitude of the person as accessed through GPS satellites. The operator's computer will link to the ALI database, which stores address data and other information. Note: Wireless service providers would benefit by deploying the SAFETYLERT invention, as the “FCC E911 program, phase 2” requires wireless service providers to more accurately locate cell phones in case of emergencies. The phone manufactures, service providers and PSAP's have not been able to comply with the deadline.

This present invention, Safetylert, will alleviate the cost/expense (i.e. software, new equipment, training, etc.) of Phase II to counties, states government, etc. Additionally, it has revenue generating aspects.

Understanding Voice Over Internet Protocol (VoIP):

What is VoIP? Voice over Internet Protocol (VoIP) is a form of communication that allows you to make phone calls over a broadband internet connection instead of typical analog telephone lines. Basic VoIP access usually allows you to call others who are also receiving calls over the internet. Interconnected VoIP services also allow you to make and receive calls to and from traditional landline numbers, usually for a service fee. Some VoIP services require a computer or a dedicated VoIP phone, while others allow you to use your landline phone to place VoIP calls through a special adapter.

VoIP is becoming an attractive communications option for consumers. Given the trend towards lower fees for basic broadband service and the brisk adoption of even faster internet offerings, VoIP usage should only gain popularity with time. However, as VoIP usage increases, so will the potential threats to the typical user. While VoIP vulnerabilities are typically similar to the ones users face on the internet, new threats, scams, and attacks unique to IP telephony are now emerging.

Service Limitations: When considering VoIP service, you should not assume that its features, functionality, and options will equal those of traditional landlines; you should be familiar with the requirements, availability, and possible service limitations of VoIP service before switching to VoIP as either a primary means of communication or an enhancement to your current services.

E911/911 Services: E911/911 services are not guaranteed with a basic (VoIP to VoIP) setup. However, it is available with many of the interconnected services that extend VoIP connectivity to traditional landlines. You should not assume that 911 services are present and working (even with interconnected VoIP services) but should consult with the terms of your service agreement. The FCC has described some of the challenges of VoIP services and has provided tips for VoIP subscribers. For more information, visit the FCC Consumer Facts VOIP 911 website.

### BRIEF DESCRIPTION OF THE DRAWINGS

In the Drawings:

FIG. 1 and FIG. 1A, is a flow diagram, illustrates embodiment for a method/apparatus of a communication device(s) for contacting and providing relevant emergency data information to a PSAP in accordance and as it relates to the present invention;

FIG. 2, is a diagram, in a perspective three view drawing, illustrates embodiment for a method/apparatus of a communication device(s) for contacting and providing relevant emergency data information to a PSAP in accordance and as it relates to the present invention;

FIG. 3, is a diagram, illustrating a top view of FIG. 2, embodiment for a method/apparatus of a communication device(s) for contacting and providing relevant emergency data information to a PSAP in accordance and as it relates to the present invention;

FIG. 4 and FIG. 5, is a diagram, illustrating a side view of FIG. 2 & FIG. 3, embodiment for a method/apparatus of a communication device(s) for contacting and providing relevant emergency data information to a PSAP in accordance and as it relates to the present invention;

### DESCRIPTION OF DRAWINGS/EMBODIMENTS

This application Claims benefit to U.S. Provisional application patent application No. 61/029,662 and U.S. Non Provisional Application No. 12/070,674, which is hereby incorporated by reference. While this invention and respective device(s) have been described and illustrated in various embodiments, such descriptions are merely illustrative of this invention and respective device(s) and are not to be construed to be limitations thereof. In this regard, this invention and respective device(s) encompasses any and all modifications, variations and/or alternative embodiments with the scope of this invention being limited only by the claims which follow. Current and future wireless technology is to be considered incorporated within each respective device, i.e. IDEN, ESN, NAM, WIDEN, UMTS, MIN, PCS, etc.

This present invention relates generally to wireless communications and emergency services. Safetylert, is an apparatus and method of an equipped GPS/A-GPS, GPS Reverse Geocoder wireless remote unit and/or an equipped GPS/A-GPS, GPS Reverse Geocoder wireless cell phone, also referred to as “communication device(s)” that can automatically transmit relevant information to a PSAP, when emergency services (i.e. 911) is prompted (emergency button) and/or dialed; the transmitted data information will enhance personal and medical safety, etc.; it will aid in countering terrorism (this equipment can be embedded within and applied to Voice Over Internet Protocol telephones, commonly known as “IP or VOIP” telephones, etc.). A Public Safety Answering Point (PSAP) is a call center responsible for answering calls to an emergency telephone number (i.e. 911) for police, firefighting, and ambulance. Trained telephone operators are usually responsible for dispatching these emergency services.

The inventive step of this present invention, Safetylert, is the installation of the GPS Reverse geocoder database software technology embedded within the equipped GPS/A-GPS wireless “remote unit” and/or an equipped GPS/A-GPS wireless “cell phone handset”. Embedding the GPS reverse geocoder database software technology within each respective device(s), enables the ability for device(s) to automatically transmit relevant data information (i.e. actual street address format, and other non traditional formats, etc.) to a PSAP operator, when “911” is prompted (emergency button) and/or dialed; aiding the PSAP operator with necessary location/tracking information to dispatch emergency responders to the device location. Again, this equipment/inventive step can be embedded within and applied to “VOIP” telephones, etc.

The GPS reverse geocoder database software technology, embedded within each respective device, significantly increase the accuracy of address intelligence and emergency response time, quickly locating device.

The embodiment of this invention will give emergency officials the capability of intervening or preventing an act of crime; prompt assistance in a medical emergency, prevents the loss of valuable time, etc.

The information transmitted to the E911/911 emergency service (PSAP) from the equipped GPS/A-GPS, GPS Reverse Geocoder wireless remote unit and/or equipped GPS/A-GPS, GPS Reverse Geocoder wireless cell phone is similar to the traditional landline format. A brief overview of a traditional landline and of existing PSAP (E911/911 emergency call centers); as well as FCC “E911” Program/Phases and “VOIP” is further documented and discussed within the patent application.

SAFETYLERT, equipped GPS/A-GPS, GPS Reverse Geocoder wireless remote unit and/or equipped GPS/A-GPS, GPS Reverse Geocoder wireless cell phone can be modified to be used globally (i.e. GSM, etc.). Global Standard for Mobile Communication “GSM” digital cellular technology developed by European countries to facilitate pan-European roaming. GSM uses time division multiple access technology and operates at both cellular and PCS frequencies. Other technologies used are CDMA, PDC and TDMA, etc.

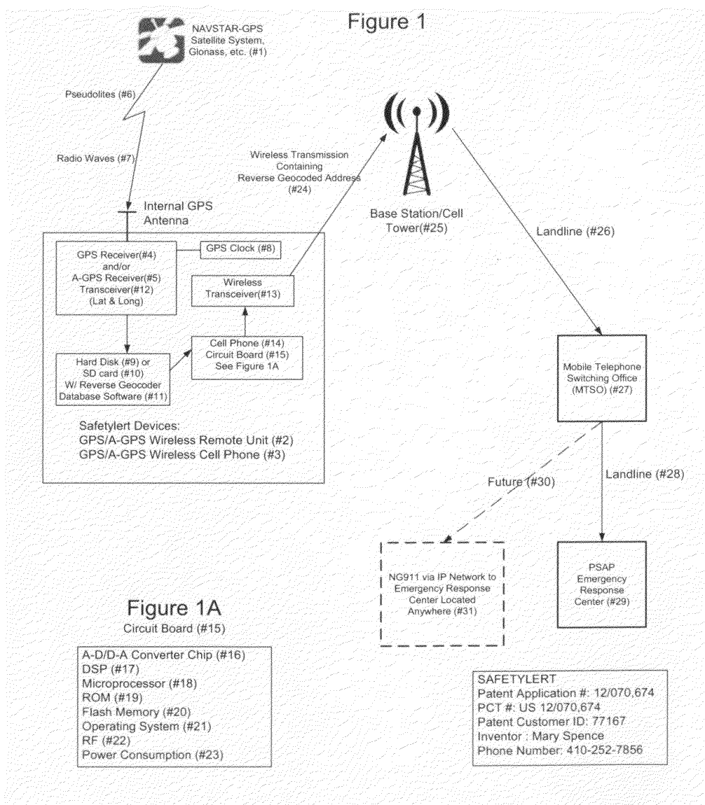

FIG. 1, shows a flow diagram, illustrating one embodiment for a method/apparatus of a communication device(s) for contacting and providing relevant emergency data information to a PSAP in accordance and as it relates to the present invention; referenced description of some, but not limited to all, of the components and equipment, etc. within each respective device(s) as they relate to this present invention:

FIG. 1, #1; illustrates the Global Positioning System: A worldwide navigation system owned and operated by the US government. GPS consists of 24 active satellites that communicate with a ground control system and GPS receivers to provide accurate latitude, longitude, time and bearing 24 hours a day, worldwide.

The Global Positioning System (GPS) is actually a constellation of 27 Earth-orbiting satellites (24 in operation and 3 backup in case one fails); the federal government (U.S. military) developed and implemented this satellite network as a military navigation system, but soon opened it up freely to everybody else. FIG. 1, #1 represents the plurality of the GPS satellites orbiting the earth.

Each of these 3,000- to 4,000-pound solar-powered satellites circle the globe at an altitude of 12,000 miles (19,300 km), making two complete rotations every day. The orbits are arranged so that at any time, anywhere on Earth, there are at least four satellites “visible” in the sky.

In situations with limited or no visibility of the GPS satellites, ground transmitters that emulate the signal structure of the GPS satellites “pseudolites” can be used as additional or replacement signal sources. See FIG. 1, #7 for explanation of radio waves.

Also used or referred to as Naystar, Radio Navigation, GLONASS, GNSS, etc.

FIG. 1, #6; illustrates Pseudolites: In situations with limited or no visibility of the GPS satellites, ground transmitters that emulate the signal structure of the GPS satellites “pseudolites” can be used as additional or replacement signal sources.

FIG. 1, #7; illustrates RF/Radio Waves: Radio Frequency “RF” is frequencies of electromagnetic spectrum normally associated with the transmission radio waves. Sometimes used to distinguish communication by wireless technologies, as opposed to transmission via wire. See FIG. 1, #22 for further documentation of “RF”.

Radio Waves are electromagnetic energy, which means they travel at the speed of light (about 186,000 miles per second, 300,000 km per second in a vacuum). The GPS receiver can figure out how far the signal has traveled by timing how long it took the signal to arrive. The GPS receiver calculates the distance to GPS satellites by timing a signal's journey from satellite to receiver.

The satellite transmits a long digital pattern called a pseudo-random code. When the satellite signal reaches the receiver, its transmission of the pattern will lag a bit behind the receiver's playing of the pattern, the length of the delay is equal to the signal's travel time.

The receiver multiplies this time by the speed of light to determine how far the signal traveled. Assuming the signal traveled in a straight line, this is the distance from receiver to satellite.

In order for the distance information to be of any use, the receiver also has to know where the satellites actually are. This isn't particularly difficult because the satellites travel in very high and predictable orbits.

The GPS receiver simply stores an almanac that tells it where every satellite should be at any given time. Things like the pull of the moon and the sun do change the satellites' orbits very slightly, but the Department of Defense constantly monitors their exact positions and transmits any adjustments to all GPS receivers as part of the satellites' signals.

The most essential function of a GPS receiver is to pick up the transmissions of at least four satellites and combine the information in those transmissions with information in an electronic almanac, all in order to figure out the receiver's position on Earth. Once the receiver makes this calculation, it can tell you the latitude, longitude, and altitude (or some similar measurement) of its current position.

FIG. 1, #2; illustrates a preferred embodiment within the Safetylert, GPS/A-GPS Wireless Remote Unit: Communication device, an equipped GPS/A-GPS wireless remote unit, that can automatically transmit relevant data information to a PSAP, when emergency services (i.e. 911) is prompted (emergency button) and/or dialed. A Public Safety Answering Point (PSAP) is a call center responsible for answering calls to an emergency telephone number (i.e. 911) for police, firefighting, and ambulance.

The inventive step of this present invention is the installation of the GPS Reverse geocoder; having the GPS reverse geocoder database software technology embedded within the equipped GPS/A-GPS wireless remote unit device, enables the ability for the device to automatically transmit relevant data information (i.e. actual street address format, and other non traditional formats, etc.) to a PSAP operator, when “911” is prompted (emergency button) and/or dialed.

Long-Felt Need: This problem and particular technology area facing wireless telecommunications and the E911/911 system (as well as VOIP, etc.) has gone unsolved for a prolonged period. The presumption is if the solution had been obvious to those skilled in the art, they would have solved the problem.

FIG. 1, #3; illustrates a preferred embodiment within the Safetylert, GPS/A-GPS Wireless Cellular Phone: Communication device, an equipped GPS/A-GPS wireless cell phone, that can automatically transmit relevant data information to a PSAP, when emergency services (i.e. 911) is prompted (emergency button) and/or dialed. A Public Safety Answering Point (PSAP) is a call center responsible for answering calls to an emergency telephone number (i.e. 911) for police, firefighting, and ambulance.

The inventive step of this present invention is the installation of the GPS Reverse geocoder database software technology embedded within the equipped GPS/A-GPS wireless cell phone handset/device, enables the ability for the device to automatically transmit relevant data information (i.e. actual street address format, and other non traditional formats, etc.) to a PSAP operator, when “911” is prompted (emergency button) and/or dialed.

Long-Felt Need: This problem and particular technology area facing wireless telecommunications and the E911/911 system (as well as VOIP, etc.) has gone unsolved for a prolonged period. The presumption is if the solution had been obvious to those skilled in the art, they would have solved the problem. p FIG. 1, #4; illustrates one embodiment of GPS Receiver: The “GPS Receiver” within each respective device(s) receives a position coordinate using the GPS satellite network, etc., (FIG. 1, #1), through Pseudolites (FIG. 1, #6) and/or RF/Radio Waves (FIG. 1, #7). The GPS satellite network (FIG. 1, #1) communicates with a ground control system and GPS receiver (FIG. 1, #4) to provide accurate latitude, longitude, time and bearing 24 hours a day, worldwide. GPS coordinates are a calculation of a precise location expressed in a specific coordinate system of latitude/longitude which can be identified on a map. Note: GPS-Aiding provides additional remote processing or GPS satellite data to support a mobile device(s) in fixing a location using GPS data.

A GPS receiver's job is to locate four or more of these satellites, figure out the distance to each, and use this information to deduce its own location. This operation is based on a simple mathematical principle called “trilateration” or “Triangulation”. Triangulation: in trigonometry and geometry, triangulation is the process of finding coordinates and distance to a point by calculating the length of one side of a triangle, given measurements of angles and sides of the triangle formed by that point and two other known reference points, using law of sines.

Receivers generally look for four or more satellites to improve accuracy and provide precise altitude information. The GPS receiver has to know: (1) the location of at least three satellites above you; (2) the distance between you and each of those satellites. The GPS receiver figures both of these things out by analyzing high-frequency, low-power radio signals from the GPS satellites. See FIG. 1, #5 and FIG. 1, #7 for additional information.

FIG. 1, #5; illustrates one embodiment of “A-GPS” Receiver: The “A-GPS (Assisted GPS) Receiver” within each respective device(s) receives a position coordinate using the GPS satellite network, etc., (FIG. 1, #1), through Pseudolites (FIG. 1, #6) and RF/Radio Waves (FIG. 1, #7). The GPS satellite network (FIG. 1, #1) communicates with a ground control system and GPS receiver (FIG. 1, #4) to provide accurate latitude, longitude, time and bearing 24 hours a day, worldwide. Note: A-GPS is a technique providing a GPS receiver with data (or equivalent information) that it would ordinarily have to download from the GPS satellites. The technique speeds the satellite acquisition time, and the time-to-fix of the GPS receiver.

Some GPS phones use wireless-assisted GPS, also called “A-GPS”, to determine the user's location. In a wireless-assisted system, the phone uses the orbiting GPS satellites, in conjunction with information about the cell phone's signal.

Sometimes call enhanced GPS, wireless-assisted GPS can often get a fix on the user's location faster than a GPS-only receiver. Some wireless-assisted systems can work inside buildings, under dense foliage and in city areas where traditional receivers cannot receive signals.

Some phones have a complete GPS receiver located in the phone or can connect to one with wires or through a Bluetooth connection. These GPS enabled phones can understand programming languages and/or work like a tracking device.

To use any of these features you must have:
1. A GPS-enabled phone or a GPS compatible receiver
2. A calling plan that supports transmission of maps and GPS data
3. A service/method plan or software that provides the actual maps and directions or provides information about the phone's location.

FIG. 1, #12; illustrates one embodiment of GPS Transceiver: The referenced GPS receiver can be a conventional instrument which is commercially available. In situations with limited or no visibility of the GPS satellites, ground transmitters that emulate the signal structure of the GPS satellites “pseudolites” can be used as additional or replacement signal sources. Transceivers (which transmit and receive GPS signals) can be used to improve standard pseudolite positioning systems. See FIG. 1, #6 for additional information concerning “pseudolites”.

If their locations are known, transceivers can be used to remove the need for the reference antenna typically necessary in standard differential systems. By using either the GPS satellite signals or other transceiver signals, a self surveying transmitter array can be implemented, eliminating the need for a prior knowledge of pseudolite locations. Pseudolite transceivers receive and transmit GPS signals.

Transceivers give many benefits beyond those associated with simple pseudolites, and can often enable the use of GPS positioning for applications where pseudolite transmitters alone may be inadequate. As with simple pseudolites, GPS transceivers can have many different features, signal structures, and implementations.

FIG. 1, #8; illustrates one embodiment of GPS Clock: The receiver and satellite both need clocks that can be synchronized down to the nanosecond. To make a satellite positioning system using only synchronized clocks, you would need to have atomic clocks not only on all the satellites, but also in the receiver itself. But atomic clocks cost somewhere between $50,000 and $100,000, which makes them a just a bit too expensive for everyday consumer use.

The Global Positioning System has a clever, effective solution to this problem. Every satellite contains an expensive atomic clock, but the receiver itself uses an ordinary quartz clock, which it constantly resets. In a nutshell, the receiver looks at incoming signals from four or more satellites and gauges its own inaccuracy. In other words, there is only one value for the “current time” that the receiver can use. The correct time value will cause all of the signals that the receiver is receiving to align at a single point in space. That time value is the time value held by the atomic clocks in all of the satellites. So the receiver sets its clock to that time value, and it then has the same time value that all the atomic clocks in all of the satellites have. The GPS receiver gets atomic clock accuracy “for free.”

GPS Clock Overview:

The receiver can easily calculate the necessary adjustment that will cause the three or four spheres to intersect at one point. Based on this, it resets its clock to be in sync with the satellite's atomic clock. The receiver does this constantly whenever it's on, which means it is nearly as accurate as the expensive atomic clocks in the satellites. Utilizing the wireless cellular phone technology; a watch battery is used by the cell phone's internal clock chip.

FIG. 1, #9; illustrates a preferred embodiment of GPS Reverse Geocoder Database Software-“Hard Disk”: A storage device option to house the GPS reverse geocoder database software. (i.e. SIM Card: chip/card that contains user account information and can be individually programmed for personalized services, for example, ArcGis is a complete system for authoring, serving, and using geographic information. It is an integrated collection of GIS software products for building and deploying a complete GIS wherever it is needed, on desktops, servers, or custom applications, etc.; GIS integrates hardware, software, etc.).

FIG. 1, #10; illustrates a preferred embodiment of GPS Reverse Geocoder Database Software-“SD Card”: A storage device option to house the GPS reverse geocoder database software (i.e. SIM Card: chip/card that contains user account information and can be individually programmed for personalized services, for example, ArcGis is a complete system for authoring, serving, and using geographic information. It is an integrated collection of GIS software products for building and deploying a complete GIS wherever it is needed, on desktops, servers, or custom applications, etc. GIS integrates hardware, software, etc.).

FIG. 1, #11; illustrates a preferred embodiment of GPS Reverse Geocoder Database Software: This database software technology is utilized to process and convert GPS latitude-longitude coordinates into a street address format and/or descriptive location, etc.

Geocoding tools such as “Reverse Geocoding” (database software technology) can identify and generate map-location and/or nearest street address to a latitude-longitude coordinate and vice versa. Geocoding database software technology can significantly increase the accuracy of address intelligence and emergency response time; quickly locating the customer i.e. child, adult, senior, etc. (i.e. utilizing a Geographic Information System “GIS” a mapping system which combines positional data with descriptive information to form a layered map).

GPS Reverse Geocoder database software technology to include street network data assigned by the U.S. Postal Service or software that is equal or better that can identify adjacent cross streets; geocoding the customer information data and displaying on a map, you can get quick indication of location. Mapping and reverse geocoding can also be applied to many countries around the world. Respective device(s) can be modified to be used globally (i.e. SIM Card: chip/card that contains user account information and can be individually programmed for personalized services, for example, ArcGis is a complete system for authoring, serving, and using geographic information. It is an integrated collection of GIS software products for building and deploying a complete GIS wherever it is needed, on desktops, servers, or custom applications, etc. GIS integrates hardware, software, etc.).

Again, the inventive step of this present invention is the installation of the GPS Reverse geocoder database software technology embedded within the equipped GPS/A-GPS wireless “remote unit” and/or an equipped GPS/A-GPS wireless “cell phone handset”. Embedding the GPS reverse geocoder database software technology within each respective device(s), enables the ability for the device(s) to automatically transmit relevant data information (i.e. actual street address format, and other non traditional formats, etc.) to a PSAP operator, when “911” is prompted (emergency button) and/or dialed; aiding the PSAP operator with necessary location/tracking information to dispatch emergency responders to the device location.

As previously stated, it is essential for each state to utilize geocoding tools (i.e. GPS reverse geocoder database software technology), etc. as part of their E911 system implementation; the remote unit and/or cell phone customer in distress may not know their current location or may become unavailable.

Again, the GPS reverse geocoder database software technology embedded within each respective device(s) significantly increases the accuracy of address intelligence and emergency response time, quickly locating device(s).

FIG. 1, #14; illustrates one embodiment of Wireless Cellular Phone Technology and Network Technologies: Inside each SAFETYLERT remote unit(s) is wireless cellular phone technology. Digital cell phones are the second generation (2G) and third generation (3G) of cellular technology. The Next Generation (NG) is currently being developed and deployed.

Cell-phone Network Technologies-2G:

There are three common technologies used by 2G cell-phone networks for transmitting information:
1. Frequency division multiple access (FDMA)—FDMA puts each call on a separate frequency.
2. Time division multiple access (TDMA)—TDMA assigns each call a certain portion of time on a designated frequency.
3. Code division multiple access (CDMA)—CDMA gives a unique code to each call and spreads it over the available frequencies.

The first word tells you what the access method is. The second word, division, lets you know that it splits calls based on that access method. The last part of each name is multiple access. This simply means that more than one user can utilize each cell.

Cell-phone Network Technologies-3G:

The 3G technology is the latest in mobile communications. 3G stands for “third generation”; this makes analog cellular technology generation one and digital/PCS generation two. 3G technology is intended for the true multimedia cell phone; typically called smartphones and features increased bandwidth and transfer rates to accommodate Web-based applications and phone-based audio and video files. 3G comprises several cellular access technologies.

The three most common ones:
1. CDMA2000—Based on 2G Code Division Multiple Access
2. WCDA (UMTS)—Wideband Code Division Multiple Access
3. TD-SCDMA—Time-division Synchronous Code-division Multiple Access

3G networks have potential transfer speeds of up to 3 Mbps (about 15 seconds to download a 3-minute MP3 song). For comparison, the fastest 2G phones can achieve up to 144 Kbps. 3G's high data rates are ideal for downloading information from the Internet and sending and receiving large, multimedia files.

The 3G phones are like mini-laptops and can accommodate broadband applications like video conferencing, receiving streaming video from the Web, sending and receiving faxes and instantly downloading e-mail messages with attachments. Of course, none of this would be possible without those soaring towers that carry cell-phone signals from phone to phone.

FIG. 1, #15; illustrates one embodiment of Circuit Board: In addition to the digital wireless cellular technology, inside each respective device(s) is a circuit board, comprised of computer chip(s). A chip is also called an integrated circuit. Generally, it is a small, thin piece of silicon onto which a transmitter making up the microprocessor has been etched. A chip might be as large as an inch on a side and contain tens of millions of transistors. Simpler processors might consist of a few thousand transistors etched onto a chip just a few millimeters square.

The circuit board inside each respective device(s) is comprised of individual computer chip(s) as follows: (FIG. 1, #15 through FIG. 1A, #23 explains circuit board)

FIG. 1A, #16; illustrates one embodiment of Analog to Digital and Digital to Analog Conversion Chip(s): These conversion chips translate the outgoing audio signal from analog to digital and the incoming signal from digital back to analog.

FIG. 1A, #17; illustrates one embodiment of Digital Signal Processor “DSP”: The digital signal processor (DSP) is a highly customized processor designed to perform signal-manipulation calculations at high speed. A specialized microprocessor that performs Digital Signal Processing functions on a data stream, used for improving the accuracy and reliability of digital communications. DSP works by clarifying, or standardizing, the levels or states of a digital signal. A DSP circuit is able to differentiate between human-made signals, which are orderly, and noise, which is inherently chaotic.

FIG. 1A, #18; illustrates one embodiment of Microprocessor: The microprocessor handles all of the housekeeping chores for the keyboard and display, deals with command and control signaling with the base station and also coordinates the rest of the functions on the board.

FIG. 1A, #19; illustrates one embodiment of ROM; and FIG. 1A, #20; illustrates one embodiment of Flash Memory Chip(s): The ROM and Flash Memory chips provide storage for the phone's operating system and customizable features, such as the phone directory. Additional information within this section.

ROM (FIG. 1A, #19): Read-only memory “ROM”; also known as firmware, is an integrated circuit programmed with specific data when it is manufactured. ROM chips are used not only in computers, but in most other electronic items as well.

Flash Memory Chip(s) (FIG. 1A, #20):

Flash Memory Chip(s) store and transfer all kinds of files on our computers—digital photographs, music files, word processing documents, PDFs and countless other forms of media. But sometimes your computer's hard drive isn't exactly where you want your information. Whether you want to make backup copies of files that live off of your systems or if you worry about your security, portable storage devices that use a type of electronic memory called flash memory may be the right solution.

FIG. 1A, #21; illustrates one embodiment of Operating System: At the simplest level, an operating system does two things:

1. It manages the hardware and software resources of the system. In a desktop computer, these resources include such things as the processor, memory, disk space and more; on a cell phone, they include the keypad, the screen, the address book, the phone dialer, the battery and the network connection.

2. It provides a stable, consistent way for applications to deal with the hardware without having to know all the details of the hardware.

FIG. 1A, #22; illustrates one embodiment of Radio Frequency “RF”: The radio frequency “RF” and power section handles power management and recharging, and also deals with the hundreds of FM channels. Finally, the RF amplifiers handle signals traveling to and from the antenna.

FIG. 1A, #23; illustrates one embodiment of Power Consumption: Wireless cellular phones have low power transmitters in them, the base station is also transmitting at low power. Low-power transmitters have an advantage; the power consumption of the wireless cellular phone, which is normally battery-operated, is relatively low. Low power means small batteries.

FIG. 1, #13; illustrates one embodiment of Wireless Transceiver: The transceiver utilizes wireless cell towers (also known as the “cellular network technology” and/or called a base station/cell site) to send the emergency wireless call and/or signal to the PSAP.

FIG. 1, #24; illustrates one embodiment of the Wireless Transmission: The wireless transmission that is between each respective device(s) and the base station/cell tower, with referenced data information.

FIG. 1, #25; illustrates a one embodiment of Base Station/Cell Tower(s); and FIG. 1, #27; illustrates one embodiment of Mobile Telephone Switching Office “MTSO”: A cell phone tower is typically a steel pole or lattice structure that rises hundreds of feet in the air. A box houses the radio transmitters and receivers that let the tower communicate with the wireless phones. The radios connect with the antenna on the tower through a set of thick cables. All of the cables and equipment at the base of the tower are heavily grounded. Cell phone towers come in all shapes and sizes.

All cell phones have special codes associated with them. These codes are used to identify the phone, the phone's owner and the service/method provider. For example; you have a cell phone, you turn it on and someone tries to call you. Here is what happens to the call: When you first power up the phone, it listens for an SID on the control channel.

When it receives the SID, the phone compares, it to the SID programmed into the phone. Along with the SID, the phone also transmits a registration request, and the MTSO keeps track of your phone's location in a database—this way, the MTSO knows which cell you are in when it wants to ring your phone. The MTSO gets the call, and it tries to find you. It looks in its database to see which cell you are in. The MTSO picks a frequency pair that your phone will use in that cell to take the call. The MTSO communicates with your phone over the control channel to tell it which frequencies to use, and once your phone and the tower switch on those frequencies, the call is connected.

A cell phone is basically a sophisticated two-way radio. Towers and base stations, arranged in a network of cells, send and receive radio signals. Cell phones contain low-power transmitters that let them communicate with the nearest tower. As you travel, you move from one cell to another, and the base stations monitor the strength of your phone's signal. As you move toward the edge of one cell, your signal strength diminishes. At the same time, the base station in the cell you are approaching notices the strength of your signal increasing. As you move from cell to cell, the towers transfer your signal from one to the next. See FIG. 1, #25 for additional description of Base Station/Cell Tower(s), and FIG. 1, #27 for additional description of Mobile Telephone Switching Office “MTSO”.

FIG. 1, #25; illustrates one embodiment of Base Station/Cell Tower(s): Wireless cellular carriers (providers) receive frequencies, for example: a carrier receives frequencies to use across a city, the carrier chops up the city into cells. Each cell has a base station that consists of a tower and a small building containing the radio equipment. The cellular approach requires a large number of base stations in a city of any size. FIG. 1, #25 represents the land-fixed cellular station (also known as the “cell tower(s)”). The land-fixed station provides two-way full duplex telephonic communication over radio channels assigned for that purpose. Cellular stations are conventional and ordinary in the United States, etc. See additional information within this section.

FIG. 1, #26; illustrates one embodiment of the Transmission via Landline: The transmission that is between the base station/cell tower, and the MTSO (carrying the referenced data).

FIG. 1, #27; illustrates one embodiment of Mobile Telephone Switching Office “MTSO”: Each carrier in each city also runs a central office(s) called the Mobile Telephone Switching Office “MTSO”. This office(s) handles all of the phone connections to the normal land-based phone system, and controls all of the base stations in the region(s). See additional information within this section.

FIG. 1, #28; illustrates one embodiment of Transmission via Landline: The transmission that is between the MTSO to the PSAP (carrying the referenced data).

FIG. 1, #29; illustrates one embodiment of the PSAP: A Public Safety Answering Point (PSAP) is a call center responsible for answering calls to an emergency telephone number (i.e. 911) for police, firefighting, and ambulance. Trained telephone operators are usually responsible for dispatching these emergency services.

The inventive step of this present invention is the installation of the GPS Reverse geocoder database software technology embedded within the equipped GPS/A-GPS wireless “remote unit” and/or an equipped GPS/A-GPS wireless “cell phone handset”. Embedding the GPS reverse geocoder database software technology within each respective device(s), enables the ability for the device(s) to automatically transmit relevant data information (i.e. actual street address format, and other non traditional formats, etc.) to a PSAP operator, when “911” is prompted and/or dialed; aiding the PSAP operator with necessary location/tracking information to dispatch emergency responders to the device location.

The embodiment of this invention will give emergency officials the capability of intervening or preventing an act of crime; prompt assistance in a medical emergency, prevents the loss of valuable time, etc. The GPS reverse geocoder database software technology embedded within each respective device(s) significantly increases the accuracy of address intelligence and emergency response time, quickly locating device(s).

The information transmitted to the E911/911 emergency service (PSAP) from the equipped GPS/A-GPS wireless remote unit and/or equipped GPS/A-GPS wireless cell phone is similar to the traditional landline format. A brief overview of a traditional landline and of existing PSAP (E911/911 emergency service center); as well as the FCC E911 phases and “VOIP” is further documented and discussed within the patent application.

FIG. 1, #30; illustrates one embodiment of Next Generation 911 System (NG911): The NG911 system as defined by the FCC; the ability to take the 911 system and put it on interne protocol (IP); currently being developed and deployed.

FIG. 1, #31; illustrates one embodiment of the Next Generation 911 System (NG911): The NG911 system as defined by the FCC; the ability to take the 911 system and put it on interne protocol (IP); currently being developed and deployed.

GPS Overview:

Like a cell phone, a GPS receiver relies on radio waves. But instead of using towers on the ground, it communicates with satellites that orbit the earth. In order to determine your location, a GPS receiver has to determine: (1) the location of at least three satellites above you; (2) where you are in relationship to those satellites. The receiver then uses trilateration to determine your exact location; it draws a sphere around each of three satellites it can locate. These three spheres intersect in two points—one is in space, and one is on the ground. The point on the ground at which the three spheres intersect is your location.

The GPS receiver has to have a clear line of sight to the satellite to operate, so dense tree cover and buildings can keep it from getting a fix on your location; see FIG. 1, #5 for additional information.

FIG. 2, is a schematic diagram, in a perspective three view drawing, illustrating embodiment for a method/apparatus (housing) of a communication device(s) for contacting and providing relevant emergency data information to a PSAP in accordance and as it relates to the present invention. With reference to FIG. 2, the housing can be sized or shaped for the particular application, illustrated without the inside wiring, etc.

FIG. 2, illustrates embodiment, the method/apparatus of respective device(s), the apparatus is shown including the herein described housing, emergency button. The housing can be sized or shaped for the particular application, description of housing components, equipment, technologies and instruments in accordance and as it relates to this present invention; referenced and described “FIG. 1 & FIG. 1A”.

With reference to FIG. 2, in one embodiment, customer encounters an emergency, the customer will prompt (press the “emergency” button) and/or dial “911” located on respective device(s); device activates, the wireless technology communications will transmit relevant data information to (PSAP). PSAP is a call center responsible for answering calls to an emergency telephone number (i.e. 911) for police, firefighting, and ambulance. Trained telephone operators are also usually responsible for dispatching these emergency services.

The inventive step of this present invention is the installation of the GPS Reverse geocoder database software technology embedded within the GPS/A-GPS wireless “remote unit” and/or an equipped GPS/A-GPS wireless “cell phone handset”. Embedding the GPS reverse geocoder database software technology within each respective device, enables the ability for the device to automatically transmit relevant data information (i.e. actual street address format, and other non traditional formats, etc.) to a PSAP operator, when “911” is prompted and/or dialed; additionally aiding the PSAP operator with necessary location/tracking information to dispatch emergency responders to the device location.

The GPS/A-GPS wireless cellular phone technology exists with “E911” technology; the GPS database software technology can be added within unit.

Once again with reference FIG. 2, in one embodiment, the respective device(s) can be worn or carried. Another embodiment, the respective device(s) can be worn as follows: (1) around the neck (2) around the wrist (3) on a belt. Again, another embodiment, respective device(s) can be a handheld, carried or placed in pocket.

Once again with reference to FIG. 2, in one embodiment, as previously stated the respective device(s) has a prompt button for emergency services (i.e. 911); in addition a siren and light is optional.

In another embodiment, addition and optional, the prompt button can transmit relevant data information to a cell phone (text), auto alarm; computer network, and/or to an alarm monitoring company if desired and monitoring company will accommodate.

In one embodiment, the method/apparatus of respective device(s), can be utilized in housings which are, or can be, utilized in telephone/wireless communication environments, in telecommunications environments, in Internet and/or networking communication environments, and/or other communication system environments; can be utilized in police/security and medical safety environments, etc.

In another embodiment, the method/apparatus of respective device(s) can also be utilized in conjunction with frames or housings used to house any one or more wires, cables, fiber optic cables, and/or any other conduction and/or connecting medium, regardless of its type, kind, and/or composition, etc.

In another embodiment, the method/apparatus of respective device(s) can be utilized in conjunction with any type, kind, size, shape, and/or orientation, of house, etc.

With reference once again to FIG. 2, the housing can be manufactured or constructed from any suitable material, such as, for example, metal, metal alloy, plastic, composite, etc., and/or any combination of same. The housing can also include, or can be constructed of, an insulating material and/or material for preventing or for reducing interference such as, but not limited to electrical interference, electrical field interference, electro-magnetic interference, electro-magnetic field interference, magnetic interference, magnetic field interference, and/or any other phenomenon, which can introduce and/or cause undesirable interference in the housing or housing environment, etc.

With reference to FIG. 2 and FIG. 5, the method/apparatus can include a pair of pin(s)/mounting brackets, as shown, which can be attached to the housing at the side(s) thereof and can extend along a portion of the side(s) of the housing as shown. The pin(s)/mounting brackets can be attached or mounted to the housing at any location and/or by any suitable manner, the pin(s)/mounting brackets can be mounted and/or attached to the housing by utilizing any appropriate hardware, bolts, nuts, etc. and/or can be formed integrally with the housing or components thereof.

The pin(s)/mounting brackets can contain holes or other means for mounting and/or attaching the various pin(s)/mounting brackets, connecting, attaching, etc., the pin(s)/mounting brackets can be manufactured from any suitable material (i.e. metal, metal alloy, plastic, composite, etc.).

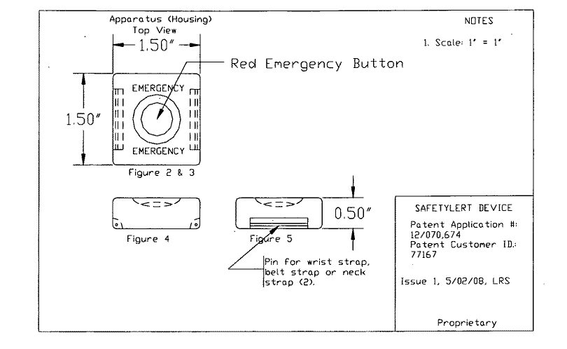

FIG. 3, is a schematic diagram, illustrating a top view of FIG. 2, embodiment for a method/apparatus of a communication device(s) for contacting and providing relevant emergency data information to a PSAP in accordance and as it relates to the present invention.

FIG. 4 and FIG. 5, is a schematic diagram, illustrating a side view of FIG. 2 & FIG. 3, embodiment for a method/apparatus of a communication device(s) for contacting and providing relevant emergency data information to a PSAP in accordance and as it relates to the present invention.

With reference to FIG. 5 and FIG. 2, the method/apparatus can include a pair of pin(s)/mounting brackets, as shown, which can be attached to the housing at the side(s) thereof and can extend along a portion of the side(s) of the housing as shown. The pin(s)/mounting brackets can be attached or mounted to the housing at any location and/or by any suitable manner, the pin(s)/mounting brackets can be mounted and/or attached to the housing by utilizing any appropriate hardware, bolts, nuts, etc. and/or can be formed integrally with the housing or components thereof.

The pin(s)/mounting brackets can contain holes or other means for mounting and/or attaching the various pin(s)/mounting brackets, connecting, attaching, etc., the pin(s)/mounting brackets can be manufactured from any suitable material (i.e. metal, metal alloy, plastic, composite, etc.).

Again, while this invention and respective device(s) have been described and illustrated in various embodiments, such descriptions are merely illustrative of this invention and respective device(s) and are not to be construed to be limitations thereof. In this regard, this invention and respective device(s) encompasses any and all modifications, variations and/or alternative embodiments with the scope of this invention being limited only by the claims which follow.

The existing PSAP (E911/911) call centers are not all located within a telephone company building; some are located within police departments or city/county locations, etc. This information is universal within the United States.

A Brief Overview of Existing PSAP:

The following is example(s) of a PSAP operator receiving an emergency call from a GPS wireless cellular phone; if the wireless cellular phone is not GPS enabled, the operator will not receive location coordinates; in addition the PSAP must have the ability i.e. Enhanced 911 to receive coordinates, etc., addition information within this section.

PSAP located within a police department (i.e. Maryland):
PSAP operator receives an emergency call from a wireless cellular phone, the PSAP operator does
not receive GPS coordinates, therefore, in the event of an emergency the police or emergency officials will
have to go back to the cellular carrier (i.e. Verizon) to see what cells tower(s) the call came from. Emergency
officials can only search the triangular area around the cell tower(s) the call originated from. The maximum
range of a cell tower (mast) where it is not limited by interference of other masts nearby varies from 20-45
miles. Valuable time is lost and the search is not accurate if the customer in distress keeps moving with their
turned on wireless cell phone and if the wireless cellular phone is turned off the call will terminate.
E911/911-PSAP located within a telephone company building:
PSAP (E911) operator receives an emergency call from a GPS wireless cell phone; the PSAP
operator will receive GPS coordinates, but not an exact address. I was informed that the telephone company's
current policy and protocol is as follows “a dispatcher is not allowed to give out the GPS coordinates” no
matter what the circumstances are due to FCC Privacy Tracking. PSAP (911) operator receives emergency
call from wireless cell phone with no information.

When someone dials 911 from a landline, the call is automatically forwarded to a public-safety answering point (PSAP), also called an E911 call center. When the call is answered, the 911 operator is immediately provided with automatic location information (ALI), pinpointing the exact position of the call; if the “caller” hangs up or can't speak the PSAP operator knows where to send help.

Due to the number of emergency calls originating from wireless cellular phones, the government has stepped in to ensure that E-911 capabilities are improved.

New technologies being developed by wireless service/method providers at the demand of the FCC are expected to enhance the location-finding ability of E-911 to locate the exact position of a wireless emergency call.

The FCC is rolling out E-911 in phases:

| | |
|---|---|
| Phase 0: | This is the basic 911 process. Wireless calls are sent to a PSAP. Service providers |
| | must direct a call to a PSAP even if the caller is not a subscriber to their service. |
| Phase I: | The FCC's rule requires that a phone number display with each wireless 911 call, |
| | allowing the PSAP operator to call back if there is a disconnection. |
| Phase II: | The final phase requires carriers to place GPS receivers in phones in order to deliver |
| | more specific latitude and longitude location information. Location information must |
| | be accurate within 164 to 984 feet (50-300 meters). |

Without Phase II, a caller's location can only be narrowed down to the cell tower from which the call originated. When Phase II is implemented, a cell-phone user's phone number, or Automatic Number Identification (ANI), and the address and location of the receiving-antenna site will be sent to the E-911 Tandem, the switch that routes 911 calls to the appropriate PSAP based on the ANI-defined geographic location.

Once the caller's voice and ANI are transferred to the PSAP, the PSAP operator will be able to view a graphic display that shows the longitude and latitude of the person as accessed through GPS satellites. The operator's computer will link to the ALI database, which stores address data and other information. Note: Wireless service providers would benefit by deploying the SAFETYLERT invention, as the “FCC E911 program, phase 2” requires wireless service providers to more accurately locate cell phones in case of emergencies. The phone manufactures, service providers and PSAP's have not been able to comply with the deadline.

This present invention, Safetylert, will alleviate the cost/expense (i.e. software, new equipment, training, etc.) of Phase II to counties, states government, etc. Additionally, it has revenue generating aspects.

Understanding Voice Over Internet Protocol (VoIP):

What is VoIP? Voice over Internet Protocol (VoIP) is a form of communication that allows you to make phone calls over a broadband internet connection instead of typical analog telephone lines. Basic VoIP access usually allows you to call others who are also receiving calls over the internet. Interconnected VoIP services also allow you to make and receive calls to and from traditional landline numbers, usually for a service fee. Some VoIP services require a computer or a dedicated VoIP phone, while others allow you to use your landline phone to place VoIP calls through a special adapter.

VoIP is becoming an attractive communications option for consumers. Given the trend towards lower fees for basic broadband service and the brisk adoption of even faster internet offerings, VoIP usage should only gain popularity with time. However, as VoIP usage increases, so will the potential threats to the typical user. While VoIP vulnerabilities are typically similar to the ones users face on the internet, new threats, scams, and attacks unique to IP telephony are now emerging.

Service Limitations: When considering VoIP service, you should not assume that its features, functionality, and options will equal those of traditional landlines; you should be familiar with the requirements, availability, and possible service limitations of VoIP service before switching to VoIP as either a primary means of communication or an enhancement to your current services.

E911/911 Services: E911/911 services are not guaranteed with a basic (VoIP to VoIP) setup. However, it is available with many of the interconnected services that extend VoIP connectivity to traditional landlines. You should not assume that 911 services are present and working (even with interconnected VoIP services) but should consult with the terms of your service agreement. The FCC has described some of the challenges of VoIP services and has provided tips for VoIP subscribers. For more information, visit the FCC Consumer Facts VOIP 911 website.

What is claimed is:

1. This present invention relates generally to wireless communications and emergency services. Safetylert, is an apparatus and method of an equipped GPS/A-GPS, GPS Reverse Geocoder wireless remote unit and/or an equipped GPS/A-GPS, GPS Reverse Geocoder wireless cell phone, also referred to as “communication device(s)” that can automatically transmit relevant information to a PSAP, when emergency services (i.e. 911) is prompted (emergency button) and/or dialed; the transmitted data information will enhance personal and medical safety, etc.; it will aid in countering terrorism (this equipment can be embedded within and applied to Voice Over Internet Protocol telephones, commonly known as “IP or VOIP” telephones, etc.). A Public Safety Answering Point (PSAP) is a call center responsible for answering calls to an emergency telephone number (i.e. 911) for police, firefighting, and ambulance. Trained telephone operators are usually responsible for dispatching these emergency services. Relevant data information that can be transmitted is further discussed within claim 2.
The inventive step of this present invention, Safetylert, is the installation of the GPS Reverse geocoder database software technology embedded within the equipped GPS/A-GPS wireless “remote unit” and/or an equipped GPS/A-GPS wireless “cell phone handset”. Embedding the GPS reverse geocoder database software technology within each respective device(s), enables the ability for device(s) to automatically transmit relevant data information (i.e. actual street address format, and other non traditional formats, etc.) to a PSAP operator, when “911” is prompted (emergency button) and/or dialed; aiding the PSAP operator with necessary location/tracking information to dispatch emergency responders to the device location. Again, this equipment/inventive step can be embedded within and applied to “VOIP” telephones, etc.
The GPS reverse geocoder database software technology, embedded within each respective device, significantly increases the accuracy of address intelligence and emergency response time, quickly locating device. The embodiment of this invention will give emergency officials the capability of intervening or preventing an act of crime; prompt assistance in a medical emergency, prevents the loss of valuable time, etc.
Long-Felt Need: This problem and particular area facing wireless telecommunications and the E911/911 system (as well as VOIP, etc.) has gone unsolved for a prolonged period. The presumption is if the solution had been obvious to those skilled in the art, they would have solved the problem.

2. The information transmitted to the E911/911 emergency service (PSAP) from the equipped GPS/A-GPS, GPS Reverse Geocoder wireless remote unit and/or equipped GPS/A-GPS, GPS Reverse Geocoder wireless cell phone is similar to the traditional landline format. A brief overview of a traditional landline and of existing PSAP (E911/911 emergency call centers); as well as FCC E911 phases and “VOIP” is further documented and discussed within the patent application and Description of Drawings.
Some of the pertinent or relevant location/tracking information provided to a PSAP, is as follows: (1) unit carrier, also known as wireless service provider; in past the assigned wireless cellular phone number depicted associated carrier name (2) assigned wireless cellular phone number (3) the location of GPS wireless remote unit and/or GPS wireless cellular phone in street address format, etc., address will automatically update if the remote unit and/or wireless cellular phone changes position/location. Further documentation and discussion within Description of Drawings. SAFETYLERT, equipped GPS/A-GPS wireless remote unit and/or equipped GPS/A-GPS wireless cell phone can be modified to be used globally (i.e. GSM, etc.).
It is essential for each state to utilize geocoding tools (i.e. GPS reverse geocoder database software technology), etc. as part of their E911 system implementation; the remote unit and/or cell phone customer in distress may not know their current location or may become unavailable; this equipment/inventive step can also be embedded within and applied to “VOIP” telephones, etc.
Again, embedding the GPS reverse geocoder database software technology within each respective device significantly increases the accuracy of address intelligence and emergency response time, quickly locating device.
Wireless service providers would benefit by deploying the SAFETYLERT invention, as the “FCC E911 program, phase 2” requires wireless service providers to more accurately locate cell phones in case of emergencies. The phone manufactures, service providers and PSAP's have not been able to comply with the deadline. Further documentation and discussion within the patent application.

3. Safetylert, is a solution as well as an invention. This present invention will: (1) improve the present E911/911 system in terms of wireless communications, i.e. GPS reverse geocoder database software technology embedded within equipped GPS/A-GPS wireless remote unit and/or equipped GPS/A-GPS wireless cell phone; (2) provide safety enhancement to consumers, as well as our country; (3) assist wireless service providers with meeting the “FCC 911 Program” requirements and deadlines; (4) opportunity for wireless service providers to create “additional revenue”, i.e. software updates etc., see #6 of this paragraph; (5) aid the government with combating terrorism; (6) afford the federal government the opportunity for “additional revenue”; via a government tax or charge for the GPS satellite network, etc. (7) the ability to have a universal E911/911 system via a central “PSAP” and/or reduce the number of “PSAP” centers needed; while improving the safety of our country.
This present invention will not only provide advantages, solution and benefits to the “E911/911” system; this equipment/inventive step can also be embedded within and applied to “VOIP” telephones, etc. In addition to possible “generating revenue” opportunity previously stated, the U.S. Postal Service has an updated address database software (i.e. Cass, etc.) that can be licensed and the information can be purchased/sold to outside vendors, similar to “Cass” etc.
The existing PSAP (E911/911) call centers are not all located within a telephone company building; some are located within police departments or city/county locations, etc. This information is universal within the United States.
A brief overview of existing PSAP: The following is example(s) of a PSAP operator. receiving an emergency call from a GPS wireless cellular phone; if the wireless cellular phone is not GPS enabled, the operator will not receive location coordinates; in addition the PSAP must have the ability i.e. Enhanced 911 to receive coordinates, etc., addition information within this section.
PSAP located within a police department (i.e. Maryland):
PSAP operator receives an emergency call from a wireless cellular phone, the PSAP operator does
not receive GPS coordinates, therefore, in the event of an emergency the police or emergency officials will
have to go back to the cellular carrier (i.e. Verizon) to see what cells tower(s) the call came from. Emergency
officials can only search the triangular area around the cell tower(s) the call originated from. The maximum
range of a cell tower (mast) where it is not limited by interference of other masts nearby varies from 20-45
miles. Valuable time is lost and the search is not accurate if the customer in distress keeps moving with their
turned on wireless cell phone and if the wireless cellular phone is turned off the call will terminate.
E911/911-PSAP located within a telephone company building:
PSAP (E911) operator receives an emergency call from a GPS wireless cell phone; the PSAP
operator will receive GPS coordinates, but not an exact address. I was informed that the telephone company's
current policy and protocol is as follows “a dispatcher is not allowed to give out the GPS coordinates” no
matter what the circumstances are due to FCC Privacy Tracking. PSAP (911) operator receives emergency
call from wireless cell phone with no information.
When someone dials 911 from a landline, the call is automatically forwarded to a public-safety answering point (PSAP), also called an E911 call center. When the call is answered, the 911 operator is immediately provided with automatic location information (ALI), pinpointing the exact position of the call; if the “caller” hangs up or can't speak the PSAP operator knows where to send help.
Due to the number of emergency calls originating from wireless cellular phones, the government has stepped in to ensure that E-911 capabilities are improved.
New technologies being developed by wireless service/method providers at the demand of the FCC are expected to enhance the location-finding ability of E-911 to locate the exact position of a wireless emergency call.
The FCC is rolling out E-911 in phases:

| | |
|---|---|
| Phase 0: | This is the basic 911 process. Wireless calls are sent to a PSAP. Service providers |
| | must direct a call to a PSAP even if the caller is not a subscriber to their service. |
| Phase I: | The FCC's rule requires that a phone number display with each wireless 911 call, |
| | allowing the PSAP operator to call back if there is a disconnection. |
| Phase II: | The final phase requires carriers to place GPS receivers in phones in order to deliver |
| | more specific latitude and longitude location information. Location information must |
| | be accurate within 164 to 984 feet (50-300 meters). |

Without Phase II, a caller's location can only be narrowed down to the cell tower from which the call originated. When Phase II is implemented, a cell-phone user's phone number, or Automatic Number Identification (ANI), and the address and location of the receiving-antenna site will be sent to the E-911 Tandem, the switch that routes 911 calls to the appropriate PSAP based on the ANI-defined geographic location.
Once the caller's voice and ANI are transferred to the PSAP, the PSAP operator will be able to view a graphic display that shows the longitude and latitude of the person as accessed through GPS satellites. The operator's computer will link to the ALI database, which stores address data and other information. Note: Wireless service providers would benefit by deploying the SAFETYLERT invention, as the “FCC E911 program, phase 2” requires wireless service providers to more accurately locate cell phones in case of emergencies. The phone manufactures, service providers and PSAP's have not been able to comply with the deadline.
This present invention, Safetylert, will alleviate the cost/expense (i.e. software, new equipment, training, etc.) of Phase II to counties, states government, etc. Additionally, it has revenue generating aspects.
Understanding Voice over Internet Protocol (VoIP):
What is VoIP? Voice over Internet Protocol (VoIP) is a form of communication that allows you to make phone calls over a broadband interne connection instead of typical analog telephone lines. Basic VoIP access usually allows you to call others who are also receiving calls over the interne. Interconnected VoIP services also allow you to make and receive calls to and from traditional landline numbers, usually for a service fee. Some VoIP services require a computer or a dedicated VoIP phone, while others allow you to use your landline phone to place VoIP calls through a special adapter.
VoIP is becoming an attractive communications option for consumers. Given the trend towards lower fees for basic broadband service and the brisk adoption of even faster internet offerings, VoIP usage should only gain popularity with time. However, as VoIP usage increases, so will the potential threats to the typical user. While VoIP vulnerabilities are typically similar to the ones users face on the internet, new threats, scams, and attacks unique to IP telephony are now emerging.
Service Limitations: When considering VoIP service, you should not assume that its features, functionality, and options will equal those of traditional landlines; you should be familiar with the requirements, availability, and possible service limitations of VoIP service before switching to VoIP as either a primary means of communication or an enhancement to your current services.
E911/911 Services: E911/911 services are not guaranteed with a basic (VoIP to VoIP) setup. However, it is available with many of the interconnected services that extend VoIP connectivity to traditional landlines. You should not assume that 911 services are present and working (even with interconnected VoIP services) but should consult with the terms of your service agreement. The FCC has described some of the challenges of VoIP services and has provided tips for VoIP subscribers. For more information, visit the FCC Consumer Facts VOIP 911 website.
